(19) United States
(12) Patent Application Publication
(10) Pub. No.: US 2005/0082068 A1
(43) Pub. Date: Apr. 21, 2005

(54) Activation indicator for pressure and temperature relief device

(76) Inventor: Jesse Michael Schneider, Sacramento, CA (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/685,964

(22) Filed: Oct. 15, 2003

(51) Int. Cl. A62C 37/14

(52) U.S. Cl. 169/58

(57) ABSTRACT

An activation indicator for a pressure and temperature relief device includes a frangible container containing a fire-extinguishing powder. The fire-extinguishing powder serves the purpose of extinguishing or preventing ignition of flammable gases released by the relief device. The powder further provides a visual and odorous indication that there has been a release of gases through the inclusion of indelible dyes, which is particularly useful in systems that use invisible, odorless gases such as hydrogen or natural gas. The frangible container is preferably a fabric pouch protected from mechanical damage and impervious to moisture to prevent premature release or contamination of the powder. The pouch is fluidly connected to the relief device so that the flow and pressure of escaping gas causes the pouch to rupture, releasing the powder to extinguish or prevent a fire in the escaping gas and to provide an indication of a release event to an observer.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The invention relates to pressure and temperature relief devices. More particularly, the invention relates to visual and odorous indication of activation of a pressure or temperature relief device.

2. Description of Related Art

Mobile and stationary systems are under continuing development that include the incorporation of alternative fuel sources such as natural gas, or alternative power sources such as electricity generated by fuel cells. Hydrogen is a commonly accepted fuel for use in fuel cells. Hydrogen is a good source of energy, but presents a challenge in that, in its gaseous state, it is flammable, colorless and odorless, and burns with an invisible flame. In an instance where hydrogen might be released, such as in an automobile accident, bystanders and emergency responders might have little warning that there has been a hydrogen release.

It would be advantageous to provide a system whereby a release of hydrogen is automatically marked by visual and odorous indicators to warn bystanders and emergency responders to the presence of the flammable gas.

### BRIEF SUMMARY OF THE INVENTION

An activation indicator for a pressure and temperature relief device includes a frangible container containing a fire-extinguishing powder. The fire-extinguishing powder serves the purpose of extinguishing or preventing ignition of flammable gases released by the relief device. The powder further provides a visual and odorous indication that there has been a release of gases through the inclusion of indelible dyes, which is particularly useful in systems that use invisible, odorless gases such as hydrogen or natural gas. The frangible container is preferably a fabric pouch protected from mechanical damage and impervious to moisture to prevent premature release or contamination of the powder. The pouch is fluidly connected to the relief device so that the flow and pressure of escaping gas causes the pouch to rupture, releasing the powder to extinguish or prevent a fire in the escaping gas and to provide an indication of a release event to an observer.

### BRIEF DESCRIPTION OF THE SEVERAL VIEWS OF THE DRAWINGS

The present invention will become more fully understood from the detailed description and the accompanying drawings, wherein:

FIG. 1 is a cross-sectional view of an activation indicator according to the invention.

### DETAILED DESCRIPTION OF THE INVENTION

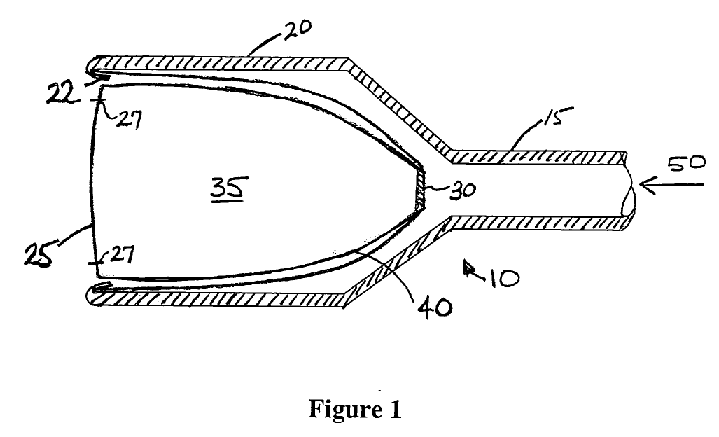

Referring to FIG. 1, an activation indicator 10 comprises a tube 15 fluidly connected to a pressure and temperature relief device (not shown), a canister 20, and a fabric pouch 40. The fabric pouch 40 is formed of a sheet of a fireproof, static dissipative material such as NODE®. The edges of the sheet are captured by the crimped edge 22 of canister 20, while the fabric is gathered into a pouch and closed by a seal 30 position at the mouth of tube 15.

The pouch is filled with a fire extinguishing powder 35, preferably a powder rated for extinguishing class ABC fires, such as various powders sold under the FUR EX name by Calico Corporation of Rotterdam, the Netherlands. In order to provide a visual and odorous indicator, indelible dye and an odor component are added to the fire extinguishing powder. This will provide warning to emergency responders and bystanders, who otherwise might not be apprised of the release of the invisible, odorless gas.

An external wall 25 of the pouch 40 is formed with perforations 27. The perforations 27 aid in the release of fire extinguishing powder 35 during a pressure/temperature relief event.

As gas 50 is released by the pressure and temperature relief device into tube 15, it exerts a force against seal 30. Seal 30 ruptures, releasing the pressure of the escaping gas 50 into the pouch 40. This pressure causes the external wall 25 to rupture at the perforations 27, releasing the fire extinguishing powder 35 to the surrounding atmosphere.

The released fire extinguishing powder 35 will provide a visual and odorous warning to any observers that there has been a release of gas. The indelible dye in the powder provides a more durable indicator should the powder (and the odor) dissipate before responders arrive on the scene. In such an instance, the first responders have an additional indication that a pressure/temperature relief system release has occurred and that hydrogen might be present.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

1. An activation indicator for a pressure and temperature relief device includes:
a frangible container containing a fire-extinguishing powder, adapted for fluidly connecting to the relief device and providing an indication of a relief event by releasing the fire extinguishing powder.

2. The activation indicator of claim 1, wherein the frangible container comprises a fabric pouch protected from mechanical damage and impervious to moisture to prevent premature release of contamination of the powder.

3. The activation indicator of claim 2, wherein the pouch is fluidly connected to the relief device so that the flow and pressure of escaping gas causes the pouch to rupture, releasing the powder to extinguish or prevent a fire in the escaping gas and to provide an indication of a release event to an observer.

4. The activation indicator of claim 2, wherein the fabric pouch is fire resistant and static dissipative.

5. The activation indicator of claim 1, wherein the fire extinguishing powder is adapted for use on class ABC fires.

6. The activation indicator of claim 1, wherein the indication of a relief event comprises a visual indicator.

7. The activation indicator of claim 6, wherein the visual indicator is produced by the inclusion of indelible dyes in the powder.

8. The activation indicator of claim 1, wherein the indication of a relief event is produced by an odorous additive to the fire extinguishing powder.
